(19) United States
(12) Patent Application Publication
(10) Pub. No.: US 2006/0250970 A1
(43) Pub. Date: Nov. 9, 2006

(54) Method and apparatus for managing capacity utilization estimation of a data center

(75) Inventors: Jingrong Gao, Richmond Hill (CA); Michael George Polan, Markham (CA); Alex Kwok Kee Tsui, Markham (CA)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/124,665

(22) Filed: May 9, 2005

(51) Int. Cl. H04J 3/22; H04J 3/16; H04Q 7/00; H04L 12/26; H04J 3/14; H04J 1/16; H04L 1/00

(52) U.S. Cl. 370/241; 370/465

(57) ABSTRACT

There is provided in an embodiment of the present invention a method, an apparatus and a program product for managing the capacity utilization estimate of a data center logical model. A data center logical model which may be based on actual physical resources of a data center physical resource is registered. An injected test load is then received which serves as the basis for a simulation, which may include fulfillment of service orders and provisioning of service orders. Usage data is next collected at the conclusion of executing injected test load. If the usage data contains a capacity utilization that does not meet a capacity threshold specified by the system owner, a further iteration of simulation may occur, in conjunction with modifying the load parameters, or changing the resources available to the data center logical model.

### CROSS REFERENCE TO RELATED PATENT APPLICATIONS

The present application is related to co-pending application entitled “Method and System for Establishing a Deployment Plan for an Application”, Ser. No. 10/870,227, attorney docket number CA920040055 which is assigned to the same assignee and incorporated herein by reference.

### BACKGROUND OF THE INVENTION

1. Technical Field

The present invention relates to the field of configuration management of hardware in a data center, and more specifically, to establishing acceptable commitments of a configured data center to tasks assigned.

2. Description of Related Art

Planning data resource center provisioning of services can be a difficult and complicated task. A data resource center is a collection of computing hardware or nodes that are interconnected via local or wide area networks. Data may be shared among members of the collection, and applications, sometimes in multiple instances, may share the work by executing on one or more such members or nodes.

Provisioning is the operation of mapping or matching available physical resources to an application such that the application has known processing, storage and interconnect features at its immediate disposal, providing, however, that no hardware failures are present. This does not mean that the application will operate error free, or avoid inadvertently (perhaps due to a programming error) congesting an interconnect or overflowing a storage, among other errors.

A data resource center may have many nodes. Ideally, these nodes are rarely idle, but are loaded to an extent that wait times for completing tasks are not unreasonably long. Overloading may happen when one or more of the processing, storage or interconnect resources are overused. Such a problem may be avoided, in the short term, by avoiding the over-commitment or under-commitment of data resource center resources to clients. In the long term, the problem is avoided by making available hardware to the data resource system, wherein the hardware is sufficient for the anticipated usage in the future.

A need exists to know the maximum test load that a simulated resource center can handle and still operate with some, but not too much, capacity to spare, for example simulating an actual data resource center under varying conditions.

### SUMMARY OF THE INVENTION

There is provided in embodiments of the present invention a method, apparatus and computer instructions for managing a capacity utilization estimate of a data center logical model, wherein the capacity utilization estimate can be expressed in terms of a test load of orders or other traffic. Registration of the data center logical model may occur. Test loads are received, having parameters, such as frequency of order or complexity of order. A data center logical model may simulate the effects of such a test load. Collection, following each round of simulation, is done to obtain usage data showing a capacity of utilization. Then for each load a determination is made as to whether the capacity utilization meets a threshold. If the threshold is met, further simulations stop, otherwise, a subsequent round of simulation begins, by modifying the test load.

### BRIEF DESCRIPTION OF THE DRAWINGS

The novel features believed characteristic of embodiments of the invention are set forth in the appended claims. The embodiments of the invention itself, however, as well as a preferred mode of use, further objectives and advantages thereof, will best be understood by reference to the following detailed description of an illustrative embodiment when read in conjunction with the accompanying drawings, wherein:

FIG. 1 shows a computer processor of an embodiment of the present invention in block form, particularly in relation to its outward appearance;

FIG. 2 shows a computer processor in further detail in accordance with an illustrative embodiment of the present invention in block form;

FIG. 3 shows a commitment embodiment of the present invention in a block diagram;

FIG. 4 shows a series of steps that may be executed by an illustrative commitment embodiment of the present invention;

FIG. 5 shows a series of steps that may be executed by an illustrative planning embodiment of the present invention; and

FIG. 6 shows a series of steps that may be executed by an illustrative model-refinement embodiment of the present invention.

### DETAILED DESCRIPTION

An order, in the first sense, is a request for a service, and optionally the provisioning of resources to deliver such a service. An order, in the second sense, is a providing of a response to a request service. In this sense, the term order is synonymous with “order processing”. The request, and responses to the order, may both be a service. The act of ordering is the act of making a request for a service, but not the act of providing a response to a request for a service.

A provisioning is the act of provisioning. The act of provisioning may itself be a service. The act of provisioning is the act of taking a request for a service perhaps with attendant time and quality parameters, and

1) selecting resources from a pool to obtain one or more allocated resources;

2) specifying interconnect parameters to one or more of the resources;

3) providing, if necessary, a way to authenticate among the allocated resources, and the origin of the service request; and

4) generally, all steps up to, but not including, the actual use of such resources to deliver a requested service. Because the present invention is concerned only with simulation, the provisioning of the present invention is of modeled resources from a pool that operates as a model of available resources. Interconnects, authentication and all setting up are performed only on data structures for hypothetical hardware and software resources.

When used as an adjective, “provisioning” is a term used to describe a dedicated physical resource that provisions, or an application that provisions.

A simulator is a device or application that simulates. The act of simulating involves executing a model of a paired service(s) and resource(s) such that the service is simplified by skipping steps of the service, or substituting steps performed. Such execution is a way to determine one or more estimated execution characteristics of the service such as: duration on a well-known or standardized processor; amount of storage; frequency of storage access; and size and profile of communications, among others.

In the context of embodiments of the present invention, the simulator is always a distinct machine from any device in the data center physical resources. Because the data center physical resources are large and costly to obtain full access, the resources are modeled in the data center logical model. The model may use theoretical formulas or statistical collections of inputs and outputs of components of the data center physical resources in order to arrive at estimates of, for example storage capacity used, and storage access frequency and volume.

An atomic service is the obtaining of a single machine language instruction on a single microprocessor, such as, performing a logical ‘or’ between two bytes.

A simple service may be a sequence of atomic services that together accomplish an intermediate step to generating a generally human perceivable output or outcome.

A complex service may be a feature level output or interaction that a human may, in typical operation, derive useful information or entertainment from, for example copying a file and reporting success or failure, playing an mp3 file to audio output, and displaying a graphic. A complex service may have fewer instructions than a simple service, but often has more instructions. In each case, a service may rely upon availability and control of one or more resources. A complex service may nest in the sense that one complex service may command execution of one or more other complex services. Unless otherwise noted, all references to a service made herein are to a complex service.

A resource is a component part or sequence of instructions that may interconnect to other resources. A resource may interconnect by establishing or specifying interconnect parameters. Interconnect parameters may include, for example, routing addresses, logical storage names, authorization, and a common set of protocols. As such, a resource may include peripheral cards, storage, routers, ports, processors, and aggregations of such components. A resource may be specified or be suited to specifying with a uniform resource locator. Unless otherwise noted, all resources have a) access to power, if applicable, and b) have a logical name or address.

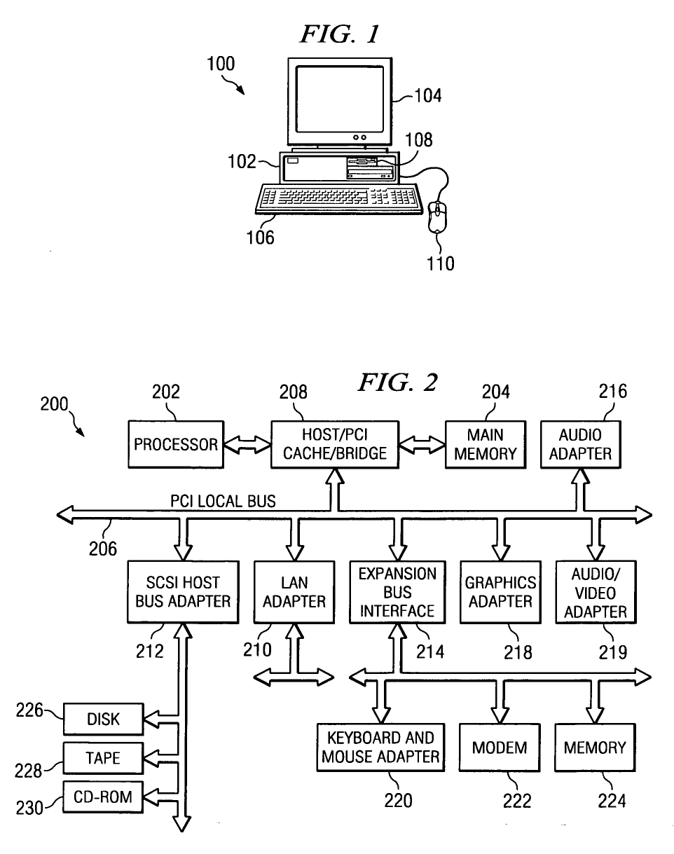

With reference now to the figures and in particular with reference to FIG. 1, a pictorial representation of a data processing system in which an embodiment of the present invention may be implemented is depicted in accordance with a preferred embodiment of the present invention. Computer 100 is depicted which includes system unit 102, video display terminal 104, keyboard 106, storage devices 108, which may include floppy drives and other types of permanent and removable storage media, and pointer device 110. Additional input devices may be included with computer 100, such as, for example, a mouse, joystick, touch screen, trackball, microphone, and the like. Computer 100 can be implemented using any suitable computer, such as an IBM Thinkpad™ computer, which is a product of International Business Machines™ Corporation, located in Armonk, N.Y. Computer 100 also preferably includes a graphical user interface (GUI) that may be implemented by means of systems software residing in computer readable media in operation within computer 100.

With reference now to FIG. 2, a block diagram of a data processing system is shown in which embodiments of the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, and small computer system interface SCSI host bus adapter are connected to PCI local bus 206 by direct component connection. In contrast, audio adapter 216, graphics adapter 218, and audio/video adapter 219 are connected to PCI local bus 206 by add-in boards inserted into expansion slots.

Expansion bus interface 214 provides a connection for keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows™ XP, which is available from Microsoft™ Corporation.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

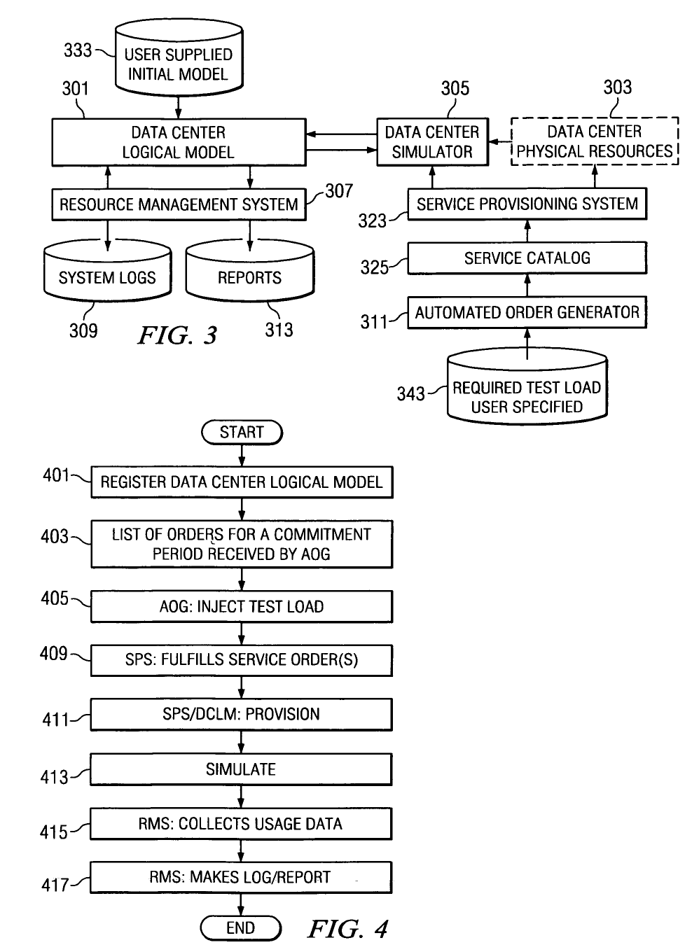

FIG. 3 shows a set of processes or applications that execute the steps of an embodiment of the present invention. Data Center Logical Model (DCLM) 301 may store the data and methods that model real data center 303. Data center 303 contains one or more nodes of computing resources. Such resources include computer processors, data storage, and networking devices, among others. The data and methods, through various shortcuts, heuristics, and other simplifications of data center 303 can establish estimated capacity usage of the ensemble that is the data center under varying circumstances. The circumstances vary based on the number of running applications on data center physical resources 303 and the parameters applicable to such applications.

Data center simulator 305 may simulate all the operations of the data center physical resources by commanding data center logical model 301.

Resource management system 307 may keep track of all the states of the data center logical model, for example, the name of each application and the loads that may be placed on such applications by simulated clients. The states tracked may be, for example, the usage level of the aggregate storage space of the data center logical model. Resource management system 307 may provide statistical data of the capacity utilization by writing such information to system logs 309, which may be one or more files or databases.

Resource management system 307 may store all execution messages from various processes, for example 301, 305, 307, 311. The execution messages may include messages on state changes of data center logical model 301, data center simulator 305, automated order generator 311, among others. A reporting program (not shown) may distill or otherwise summarize the contents of system logs to provide reports 313 for each new job scheduled, such as providing the expected capacity utilization of data center physical resources (DCPR) 303, given all concurrent jobs scheduled.

A service catalog may be represented as a list of options presented. This option may be presented in a different way, such as, for example, by a graphical user interface. The graphical user interface may take a user selected option from among the listed items and look up a corresponding form for user input. The corresponding form may provide a mechanism for a user to specify a reservation of data center physical resources which includes, among other things, a scheduled time to use the system resources, and parameters that denote the scale of the processing the user requires.

An injected test load may include a simulation of inputs or orders a user might make to the graphical user interface. Such a test load may include keystrokes and mouse movements among other things.

Automated order generator 311 generates an initial service order to service provisioning system 323, which may provide a graphical user interface. Service provisioning system 323 processes such orders to provide inputs to data center simulator 305 so that an estimate or usage data may be rapidly available. Automated order generator 311 may read a file that includes a required test load that is user specified 343, whereby one or more service orders may be derived from the file.

Alternatively, automated order generator 311 may sidestep service catalog 325 and deliver one or more reservations directly to service provisioning system 323, thus emulating the activity of service catalog 325. The reservation may be a service order.

It is appreciated that each process or application of FIG. 3 may operate on one or more processors. The one or more processors may be as configured in FIG. 2, or be one of many other processor architectures. Hence, a single processor may operate processes that are data center logical model 301, the service provisioning system 323, data center simulator 305, resource management system 307, automated order generator 311, and data center logical model 301.

A user may initially populate a user-supplied initial model 333 of the data center logical model. A user may edit, or provide other inputs to a modeling tool to specify a model in one or more files that are a user supplied initial model 333.

FIG. 4 shows steps that may occur in a service ordering and scheduling embodiment of the present invention, hereinafter referred to as a commitment embodiment. A system administrator registers or allows a device/application to register a configuration in data center logical model that matches data center physical resources 303 (step 401). Such a step may occur when resources are added to data center physical resources 303 such as, for example, when a new hard-drive is added to an available node, or when a new node is brought online in data center physical resources 303. Such a step is called synchronizing data center physical resources with the data center logical model. The registration step may comprise a step selected from add, delete and modify with respect to resources such as networking resources, storage resources, and processing resources.

An owner or other entity that controls data center physical resources 303 may establish a plan for orders that data center physical resources 303 is expected to support. The owners and operators of a typical website, example.com, for example, may know that transactions on example.com's pool of computing resources (data center physical resources) are going to be high in December. So the owners and operators of example.com may schedule a steady state of 1.8 million orders on example.com's data center physical resources that handle world wide web traffic, inventory control, secure credit transactions, and the like in the first week of December and 2.5 million orders during the second week of December. Under this example, a list of simulated orders or other profile of ordering frequency is established or otherwise received at automated order generator for one or both of those weeks (step 403).

Automated order generator (AOG) 311 stimulates the system under test, in this case the combined operation of service provisioning system 323, data center simulator 305, and data center logical model 301. Stimulation arrives as an injected test load at service provisioning system (SPS) 323 (step 405). The service provisioning system fulfills the service orders (step 409). Service provisioning system 323 may receive a request by a client, for example, operated by an outside user that wants to purchase, or is otherwise entitled to data center use. Such client initiated activity is known as a subscription of the service catalog items. Service provisioning system 323 fulfills the service order by sending a message to the data center simulator (step 411).

Data center simulator 305 receives simulated order traffic from service provisioning system 323 and through the methods and routines of data center logical model 301 simulates the model (step 413). Resource management system 307 of FIG. 3 may collect usage data (step 415). Usage data may be generated at predetermined intervals by simulation for the duration of a client's requested project or job. The simulations may be operated iteratively so that for each time segment, estimated capacity utilization is created as an output. The simulations may be operated iteratively over varying configurations, wherein the required programs for the job are executed, in simulation, on different nodes, having varying capabilities and varying locations in data center physical resources topology. The raw outputs of such a simulation may be collected into the system log (step 417).

More meaningful results may be summarized by using text parsing routines or structured queries in the event of system logs being stored in a database form.

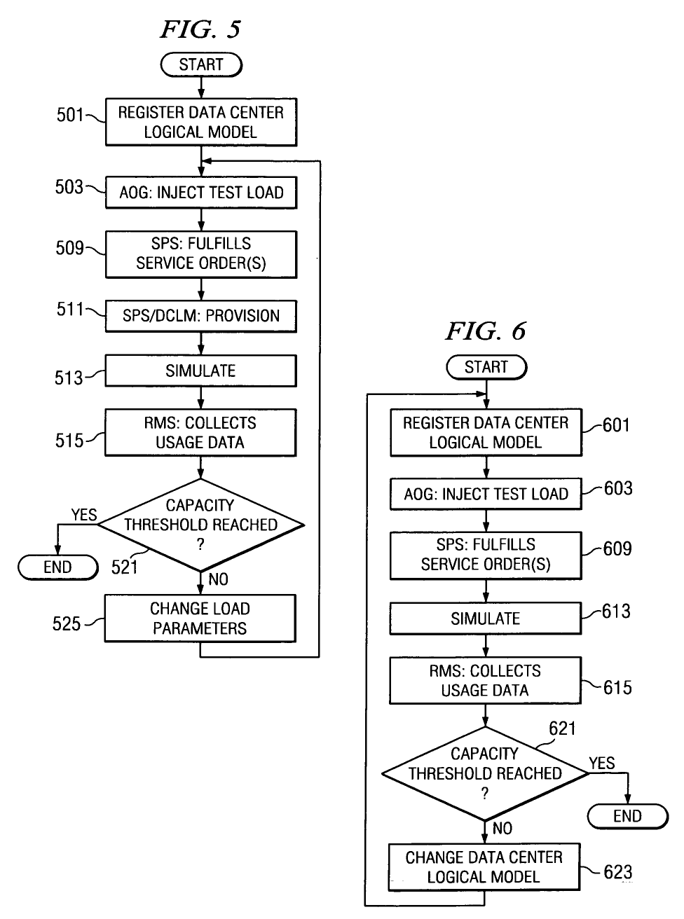

FIG. 5 shows steps that may occur in a service ordering and planning embodiment of the present invention, hereinafter referred to as a planning embodiment. A system administrator registers one or more hypothetical system configurations or profiles (step 501). Such hypothetical configurations need have no correlation to data center physical resources.

Automated order generator 311 may examine a database of simulated user or client activity that system administrators would like to use to confirm that capacity utilization falls beneath a comfortable threshold or capacity threshold, such as 95% of utilization in worst case conditions. Alternatively, user or client activity may be iteratively generated by slowly increasing load parameters, in a predetermined manner, incrementing from a minimal simulated load. One or more test conditions may be injected into the service provisioning system (step 503). The test conditions may be limited to a set of orders permitted to be made by a service catalog. A service catalog may be a limited set of user-selectable conditions for arranging and agreeing to a job. For example, in the case of a collaboration team room, a client subscribes to a room to be set up from Monday at 8:00 am to Friday at 5:00 pm. The subscription may be for up to 25 individual participants. Timing may be a widely flexible user request, and the quantity of individual participants may be limited to quantities of 5, 10, and 25.

Service provisioning system 323 fulfills the service order by sending a message to the data center simulator to provision services (step 509).

Data center simulator executes provisioning processes (step 511). Data center simulator 305 makes commands to the logical data center to cooperatively simulate the modeled data resource center. Particularly relevant is the measure of storage that is taken up during the provisioning stage (step 513).

Resource management system 307 of FIG. 3 may collect usage data generated in predetermined intervals by simulation for the duration of such a hypothetical client's requested project (step 515). In these examples, the project may be referred to as a job. The simulations may be operated iteratively so that for each time segment estimated capacity utilization is created as an output.

A test may be used to determine if the registered data center model has been overdriven or under-driven by the currently injected load (step 521). Such a test may measure, along one or more parameters, if the capacity of the modeled data center has reached a capacity threshold. One such parameter may be storage space. Another such parameter may be used capacity of a communication link. Providing the determination is “no”, the planning embodiment may change the load parameters to increase orders (step 525). The threshold could be established on the basis of storage space used under the simulation as compared to the storage space available in the data center logical model. The threshold could be set to designate a minimum percentage, for example, “at least 95%”. The initial test load could be set artificially low in relation to the modeled data center so that the threshold may be approached from below, in which case the “yes” determination at produces a test load that meets the criteria, and the process of steps ends or stops (step 521).

Otherwise, a “no” may return to change load parameters for a further iteration (step 525). As such, to be ‘at a threshold’ or to ‘reach a threshold’ may mean that the capacity measure is in a range of good values that are selected by operators of the system, wherein such a range may be open at least at one end.

FIG. 6 shows steps that may occur in a service ordering and scheduling embodiment of the present invention, hereinafter referred to as a model-refining embodiment. A system administrator registers data center logical model (DCLM) 301 (of FIG. 3) and receives a command to add resources, move resources, or otherwise modify resources (step 601). Such a command may be in the form of user supplied initial model 333 (of FIG. 3) or other user data that identifies an initial configuration or initial model that data center logical model 301 needs to prepare for simulation. An actual data center physical resources 303 is not required in this embodiment.

In this example, a list of simulated orders or other profile of ordering frequency is established. Data center simulator 305 may receive an injected test load from the automated order generator for one or both of those weeks (step 603). The load may be kept constant throughout the steps of the model-refining embodiment.

Automated order generator 311 stimulates the system under test, in this case the combined operation of service provisioning system 323, data center simulator 305, and data center logical model 301. Stimulation arrives as an injected test load at service provisioning system (SPS) 323 (step 603). Service provisioning system 323 fulfills the service orders (step 609). Service provisioning system 323 may receive a request from a client, for example, operated by an outside user that wants to purchase, or is otherwise entitled to data center use. Such client initiated activity is known as a subscription of the service catalog items. Service provisioning system 323 fulfills the service order by sending a message to the data center simulator (step 609).

Data center simulator 305 receives simulated order traffic from the SPS and through the methods and routines of data center logical model 301 simulates the model (step 613). Resource management system 307 of FIG. 3 may collect usage data (step 615). Such usage data may be generated in predetermined intervals by simulation for the duration of the client's requested project (job). The simulations may be operated iteratively so that for each time segment, estimated capacity utilization is created as an output. The simulations may also be operated iteratively over varying configurations, wherein the required programs for the job are executed, in simulation, on different nodes, having varying capabilities and varying locations in data center physical resources topology.

A test may be used to determine if the currently registered data center model has reached the capacity threshold using the currently registered data center logical model (step 621). Providing the determination is “no”, the model-refining embodiment may change the data center logical model to add an additional entity (or resource) or improve a parameter, for example, data storage, of a resource in the data center logical model (step 623). The threshold may be established on the basis storage space used under the simulation as compared to the storage space available in the data center logical model. The threshold may be such that it designates a minimum percentage, for example, “at least 95%”. The initial model could be set artificially low in relation to the injected test load so that the threshold is approached from below, in which case the “yes” determination at (step 621) produces a data center logical model that meets the criteria, and the process ends. Otherwise, a “no” returns to change data center logical model (step 623) to perform a further iteration.

It is appreciated that the capacity threshold may be a measure of several system parameters, including measurements for percentages of allocated disk usage, and percentages of network link or links usage. As such, there may be multiple capacity thresholds that are approached from either above or below. As such, the data center logical model may be changed to adjust one or more modeled resources to the point that the collective set of capacity thresholds is reached. A test for a threshold may be either “at least”, “at most”, or “within a range” (step 623).

Among the sought for benefits of one or more embodiments is a way to immediately know, at the time of a client subscription, if such a subscription will overwhelm the data center physical resources, or at least so overload the data center physical resources, that acceptable tolerances for job completion are not met.

The system log in step 417 shows if the data center physical resources are overwhelmed in such a way to produce latencies that are beyond acceptable tolerances.

Similarly, the embodiments show a way to establish a hypothetical configuration of hardware resources such that iterations of increased subscriptions can be shown to have a capacity utilization estimate for each increase such that when capacity utilization exceeds a threshold, knowledge of the limitations of the hypothetical configuration is available.

Even further, one or more embodiments may permit a scaling upward of simulated resources to see when resources are sufficient, but not overly so, to handle a particular test load.

It is important to note that while embodiments of the present invention have been described in the context of a fully functioning data processing system, those of ordinary skill in the art will appreciate that the processes of the embodiments of the present invention are capable of being distributed in the form of a computer usable medium of instructions and a variety of forms and that the embodiments of the present invention apply equally regardless of the particular type of signal bearing media actually used to carry out the distribution. Examples of computer usable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer usable media may take the form of coded formats that are decoded for actual use in a particular data processing system.

The description of the embodiments of the present invention have been presented for purposes of illustration and description, and are not intended to be exhaustive or limited to the invention in the form disclosed. Many modifications and variations will be apparent to those of ordinary skill in the art. The embodiments were chosen and described in order to best explain the principles of the invention, the practical application, and to enable others of ordinary skill in the art to understand the invention for various embodiments with various modifications as are suited to the particular use contemplated.

What is claimed is:

1. A method for managing a capacity utilization estimate of a data center configuration having a data center logical model applicable to a threshold comprising the steps of:
registering the data center logical model;
receiving a plurality of test loads having at least two parameters;
simulating the data center logical model based on each test load;
collecting usage data having a capacity utilization;
comparing each test load capacity utilization to the threshold; and
modifying each test load until the capacity utilization is at the threshold.

2. The method for managing of claim 1 wherein the step of simulating further comprises:
fulfilling at least one service order based on each test load; and
provisioning the data center logical model based on each test load.

3. The method for managing of claim 1 wherein the step of registering the data center logical model comprises:
synchronizing the data center logical model with data center physical resources.

4. The method for managing of claim 3 wherein the step of synchronizing further comprises:
receiving configuration files from the data center physical resources.

5. The method for managing of claim 4 further comprising:
fulfilling at least one service order based on each test load; and
provisioning the data center logical model based on each test load.

6. The method for managing of claim 5 wherein the step of registering comprises:
selecting an operation from add, delete and modify.

7. The method for managing of claim 6 wherein the step of modifying further comprises increasing each test load.

8. The method for managing of claim 6 wherein the capacity utilization is a storage used as compared to an available storage.

9. A method for managing a capacity utilization estimate of a test load, matched to a data center logical model, applicable to a threshold comprising the steps of:
receiving a plurality of data center logical models;
receiving a test load for use with at least one of the plurality of data center logical models;
simulating each data center logical model based on the test load;
collecting usage data having a capacity utilization;
determining for each data center logical model whether the capacity utilization is at the threshold;
modifying each data center logical model until the capacity utilization is at the threshold.

10. The method for managing of claim 9 wherein the step of simulating further comprises:
fulfilling at least one service order based on each test load; and
provisioning the data center logical model based on each test load.

11. The method for managing of claim 9 wherein the step of registering comprises:
selecting an operation from add, delete and modify.

12. The method for managing of claim 9 wherein the capacity utilization is a storage used as compared to an available storage.

13. A simulator for determining a capacity utilization estimate of a data center configuration having a data center logical model applicable to a threshold comprising:
a registration means for registering the data center logical model;
a receiver for receiving a plurality of test loads having at least two parameters;
a simulation means for simulating the data center logical model based on each test load, operatively coupled to the means for registering and the means for receiving;
a collector for collecting usage data having a capacity utilization, said collector receiving output from the simulation means;
a comparator means for determining for each test load whether the capacity utilization is at the threshold, said means comparator operatively coupled to the collector;
a means for modifying each test load until the comparator determines the capacity utilization is at the threshold.

14. The simulator for managing of claim 13 wherein the simulation means further comprises:
a fulfillment means for fulfilling at least one service order based on each test load; and
a provisioning means for provisioning the data center logical model based on each test load.

15. The simulator for managing of claim 13 wherein the registration means further comprises:
a synchronizer for synchronizing the data center logical model with data center physical resources.

16. The simulator for managing of claim 15 wherein the synchronizer further comprises:
a receiver for receiving configuration files from the data center physical resources.

17. The simulator for managing of claim 16 further comprising:
a fulfillment means for fulfilling at least one service order based on each test load; and
a provisioning means for provisioning the data center logical model based on each test load.

18. The simulator for managing of claim 17 wherein the registration means further comprises:
a means for selecting an operation from add, delete and modify.

19. The simulator for managing of claim 18 wherein the capacity utilization is a storage used as compared to an available storage.

20. A computer program product for determining a capacity utilization estimate of a data center configuration having a data center logical model applicable to a threshold comprising:
computer usable program code for receiving a plurality of data center logical models;
computer usable program code for receiving a test load for use with at least one of the plurality of data center logical models;
computer usable program code for simulating each data center logical model based on the test load;
computer usable program code for collecting usage data having a capacity utilization;
computer usable program code for determining for each data center logical model whether the capacity utilization is at the threshold; and
computer usable program code for modifying each data center logical model until the capacity utilization is at the threshold.
